(19) United States
(12) Patent Application Publication
(10) Pub. No.: US 2007/0195821 A1
(43) Pub. Date: Aug. 23, 2007

(54) Apparatus, system, and computer readable medium for reducing data transmission overhead

(76) Inventor: Lih-Chung Kuo, San Jose, CA (US)

Correspondence Address: Kunzler & McKenzie, 8 EAST BROADWAY, SUITE 600, SALT LAKE CITY, UT, 84111, US

(21) Appl. No.: 11/358,615

(22) Filed: Feb. 21, 2006

(51) Int. Cl. H04J 3/24

(52) U.S. Cl. 370/474

(57) ABSTRACT

An apparatus, system, and computer readable medium are disclosed for reducing data transmission overhead. The present invention teaches a data transmission device having a fragment receiving module that receives at least one data fragment corresponding to a data segment and a memory controller that stores the at least one data fragment within a data segment memory. The memory controller includes a data count register that tracks an accumulated data count for the data segment. If the accumulated data count attains a selected value, the memory controller forwards the data segment. In certain embodiments, the memory controller orders the data fragments within the segment memory according to a selected order. In certain embodiments, the data segment memory is capable of storing a plurality of data segments.

### BACKGROUND OF THE INVENTION

1. Field of the Invention

This invention relates to systems, methods, and apparatus for data transmission and more particularly relates to systems, methods, and apparatus for reducing data transmission overhead.

2. Description of the Related Art

Data transmission has been and continues to be a vital aspect of many types of communication systems and networks. Transmitting data includes transferring data from one location within a system to another. As the rate of innovation increases, so does the need for efficient data transmission.

Currently available data transmission approaches include dividing a data segment into multiple data fragments, and transmitting the data fragments to their respective locations or addresses. Though this approach is effective in transmitting data from one point to another, this approach also has certain shortcomings. For example, dividing a single data segment and transmitting the corresponding data fragments increases data transmission overhead, as each data fragment requires individual packaging to complete the transmission process. The greater the overhead, the smaller the relative bandwidth, and the longer it takes to transmit the original data segment. Accordingly, transmitting data segments as multiple data fragments decreases data transmission efficiency.

Additionally, the foregoing data fragment approach is exceptionally problematic in communication systems that implement software that imposes additional data fragment packaging and thereby increase data transmission overhead. More over, many communication systems are unable to use a single data fragment, and must wait for all the data fragments of a particular data segment before making use of the data. In such communication systems, a data fragment approach not only decreases data transmission efficiency, but also has little practical application.

From the foregoing discussion, it should be apparent that a need exists for a system, apparatus, and method for reducing data transmission overhead. Beneficially, such a system, apparatus and method would substantially decrease data transmission overhead by collecting multiple data segments and transmitting instead a single data fragment.

### SUMMARY OF THE INVENTION

The present invention has been developed in response to the present state of the art, and in particular, in response to the problems and needs in the art that have not yet been filly solved by currently available solutions. Accordingly, the present invention has been developed to provide an apparatus, system, and method for reducing data transmission overhead.

An apparatus of the present invention is provided to reduce data transmission overhead. The apparatus in the described embodiments includes a fragment receiving module, a memory controller, and a data segment memory. The fragment receiving module receives one or more fragment corresponding to a data segment. The memory controller stores the data fragments within a data segment memory. The memory controller includes a data count register that tracks an accumulated data count for the data segment. If the accumulated data count attains a selected value, the memory controller forwards the data segment. In certain embodiments, the selected value represents an anticipated quantity of data or data segment size. In certain embodiments, the apparatus includes a transmission module configured to transmit a selected data segment.

In certain embodiments, each of the data fragment includes a memory address. In such embodiments, the memory controller may be designed to store the data fragment only if the memory address is within the selected range of memory addresses. In certain embodiments, the memory controller also orders the data fragments according to a particular order such as an anticipated data fragment reception order. In some embodiments the memory controller is capable of storing data fragments that corresponding to different data segments within the data segment memory.

The memory controller may forward any data fragments in response to an error. Examples of an error may include receiving one or more data fragments out of order or receiving a data fragment having a memory address outside of a selected range of memory addresses. In certain embodiments, the memory controller forwards any data fragments within the data segment memory according to a selected interval of time.

A system of the present invention is also presented for reducing data transmission overhead. The system may be embodied as a data fragment source, a data transceiver, and a data segment receiver. The data fragment source communicates one or more data fragments that are received by the data transceiver. The data transceiver also stores the data fragments and tracks an accumulated data count for the data segment. The data transceiver forwards the data segment if the accumulated data count attains a selected value. The data segment receiver receives the data segment. In certain embodiments, the fragment source is an integrated circuit and the data segment receiver includes a data bearing medium.

A method of the present invention is also presented for reducing data transmission overhead. The method in the disclosed embodiments substantially includes the operations necessary to carry out the functions presented above with respect to the operation of the described apparatus and system. In one embodiment, the method includes receiving one ore more data fragments corresponding to a data segment, storing the data fragments, tracking an accumulated data count for the data segment, and transmitting the data segment if the accumulated data count attains a selected value.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram of one embodiment of a data transmission system in accordance with the present invention;

FIG. 2 is a schematic block diagram of one embodiment of a data transceiver in accordance with the present invention;

FIG. 3 is a schematic block diagram of one embodiment of a memory controller in accordance with the present invention;

FIG. 4 is a schematic flow diagram of one embodiment of data transmission method in accordance with the present invention;

FIGS. 5a-5i are schematic block diagrams of one embodiment a data transceiver in accordance with the present invention; and

FIGS. 6a-6c are schematic block diagrams of one embodiment of data transceiver in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, among different processors, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of generating a signal, causing a signal to be generated, or causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

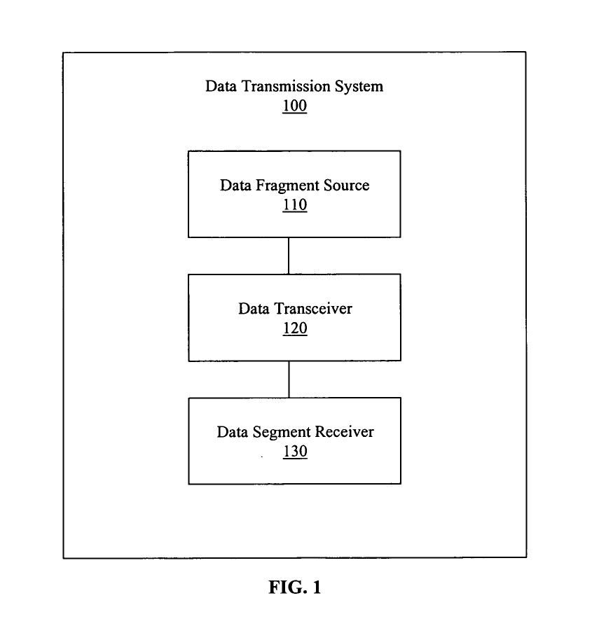

FIG. 1 is a schematic block diagram of a data transmission system 100. The depicted system 100 includes a data fragment source 110, a data transceiver 120, and a data segment receiver 130. The various components of the system 100 cooperate to reduce data transmission overhead by collecting high-overhead data fragments and transmitting a low-overhead data segment.

The data fragment source 110 may include any device (or plurality of devices) capable of communicating one or more data fragments corresponding to a data segments. In certain embodiments, the data fragment source 110 is a single device such as an integrated circuit or PCI interface. In other embodiments, the depicted data fragment source 110 may represent a plurality of devices capable of communicating one or more data fragments. The means of communicating data fragments from the data fragment source 110 to data transceiver 120 is not meant to limit the scope of the present invention in any way, and may include any variety means suggested by the computer readable medium described above.

As will be further detailed throughout this specification, the data transceiver 120 receives and stores one or more data fragments. The data transceiver 120 also tracks the data count for the data segment. If the data count attains a selected value, the data transceiver 120 forwards the data segment to the data segment receiver 130. As will be further detailed in subsequent figures, in certain embodiments, the data transceiver 120 may store data fragments corresponding to different data segments. In other embodiments, the data transceiver may also order stored data fragments according to a selected or prescribed order.

The data segment receiver 130 receives the data segment from the data transceiver 120. The data segment receiver 130 may include a data storage device such as a device having volatile or nonvolatile memory. The data segment receiver 130 may also include a communication oriented device such as a router, hub, switch, or the like. In certain embodiments, the data segment receiver 130 may represent several devices such as a data storage device behind a router or a network of devices. Accordingly, the system 100 reduces data transmission overhead by converting the data fragments into a data segment, and communicating the data segment to a data segment receiver 130.

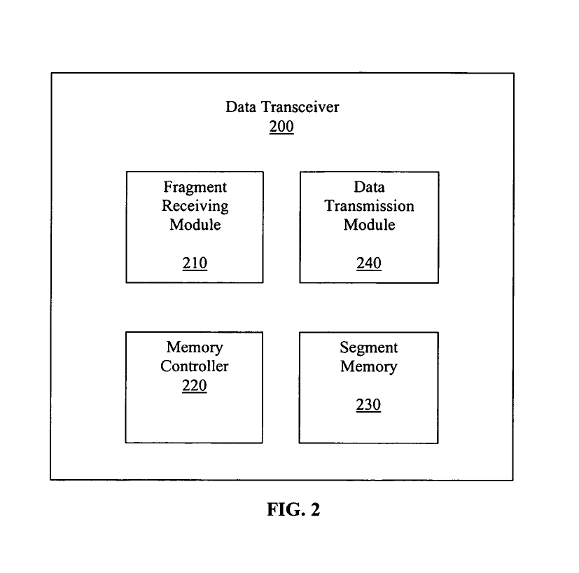

FIG. 2 is a schematic block diagram of a data transceiver 200. The depicted data transceiver 200 includes a fragment receiving module 210, a memory controller 220, a segment memory 230, and a data transmission module 240. The various components of the data transceiver 200 increase data transmission efficiency by reducing data transmission overhead.

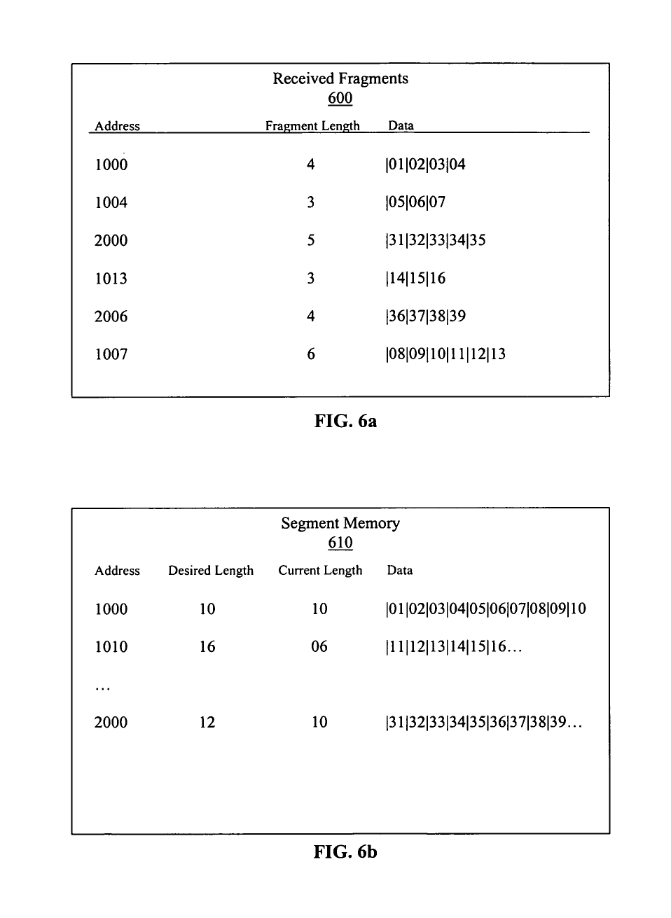

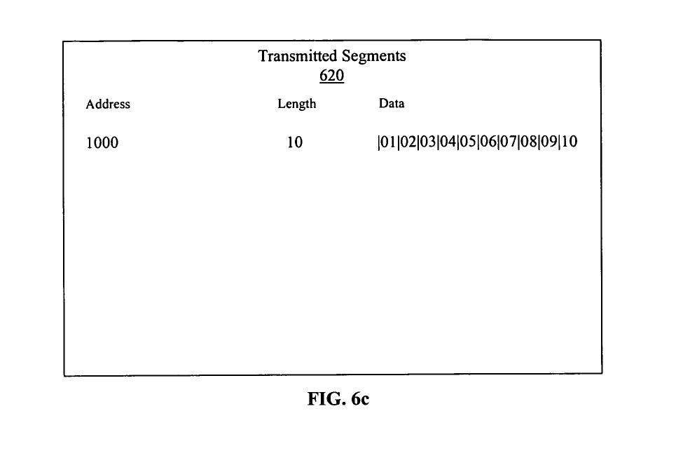

The fragment receiving module 210 receives one or more data fragments corresponding to a data segment. The memory controller 220 stores the data fragments within the data segment memory 230. In some embodiments, if a data fragment is received contrary to an anticipated data fragment reception sequence, the memory controller 220 orders the data fragments stored in the segment memory 230 according to a selected order such as an anticipated fragment reception order (see FIG. 6).

In certain embodiments, the segment memory 230 is capable of storing multiple data segments simultaneously (see FIG. 6). In some embodiments, the segment memory 230 stores two (2) data segments. In such embodiments, one data segment may be forwarded while the other data segment is being gathered. The data transmission module 240 forwards the stored data segment if the accumulated data count attains a selected value such the anticipated segment size or length.

In certain embodiments, the transmission module 240 also forwards a data fragment in response to an error. An error may include, for example, receiving one or more fragments contrary to an anticipated reception order, receiving a fragment with a memory address outside a selected memory address range, receiving a duplicate data fragment, or not having sufficient memory space within the segment memory to store a received data fragment. What constitutes an error will depend upon the particular embodiment.

In certain embodiments the transmission module 240 also forwards data segments according to a selected interval of time. Forwarding data segments according to a selected interval of time may include forwarding a data segment from the segment memory 230, then waiting for a given period of time to transpire before transmitting another data segment from the segment memory 230. In other embodiments, an interval of time may be the time between receiving two data fragments.

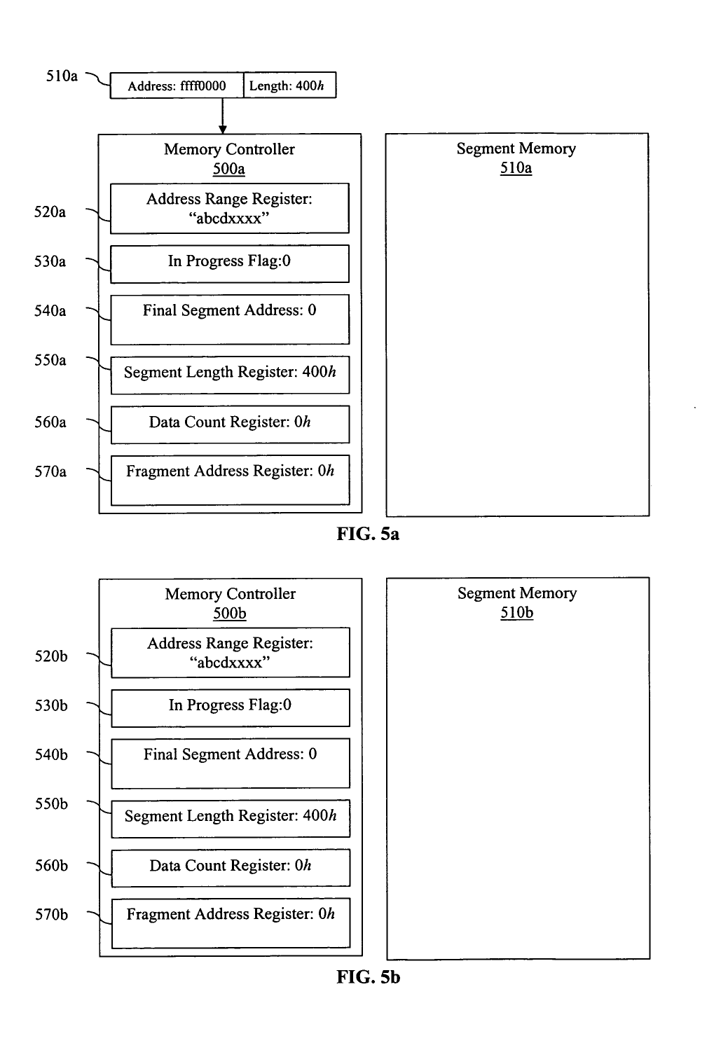

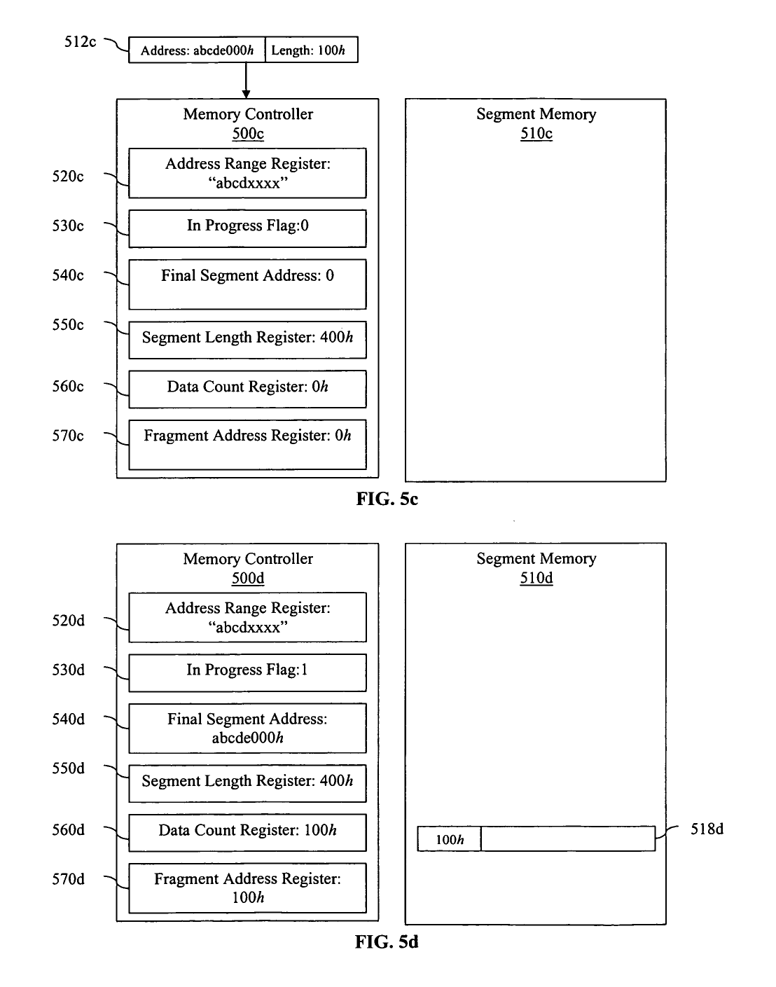

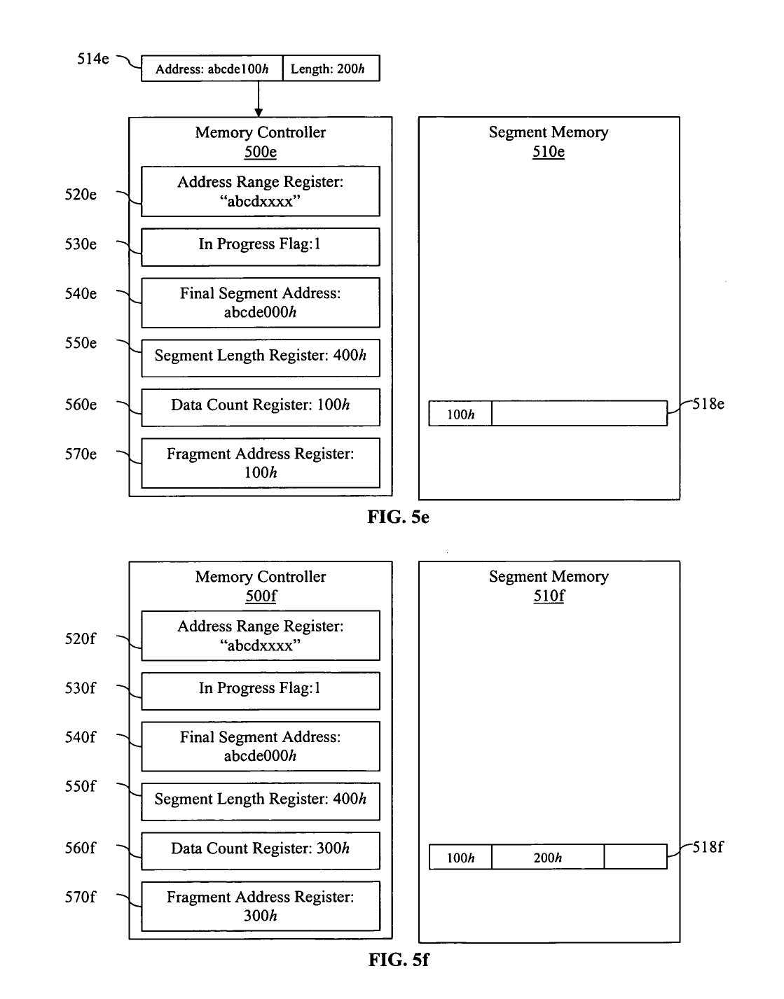

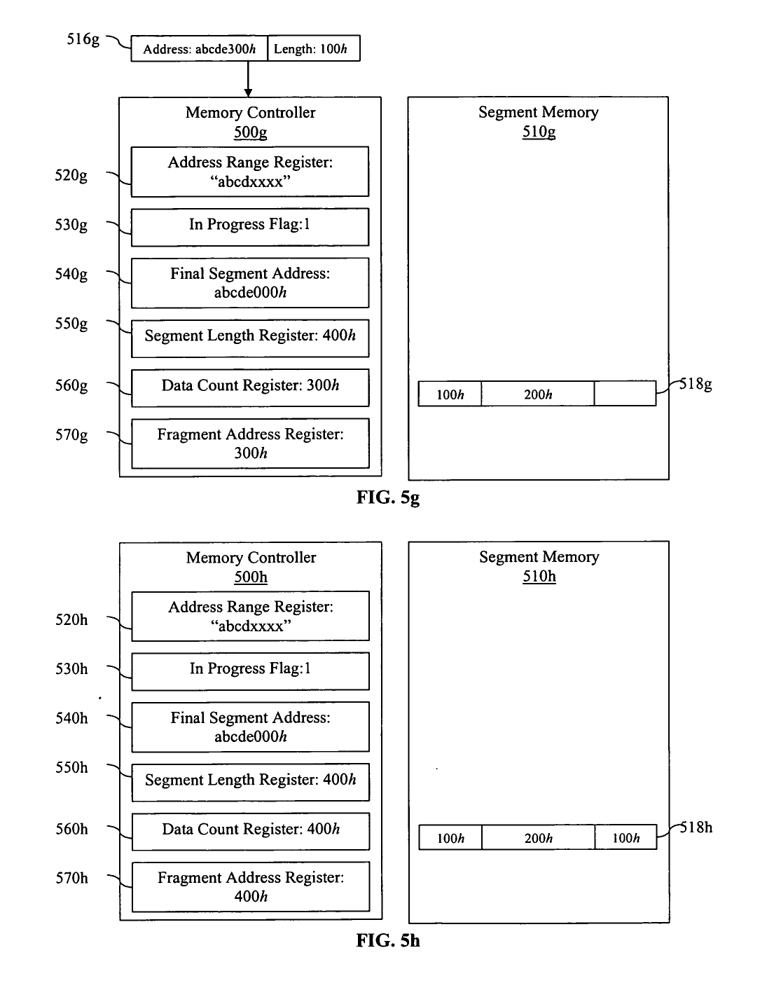

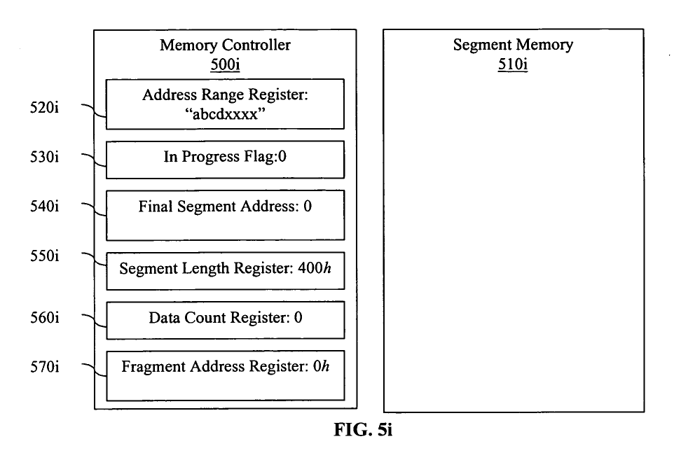

In certain embodiments, a data fragment includes a memory address. In such embodiments, the memory address may correspond to a location within the data segment receiver 130 of FIG. 1. Also, the memory controller 220 may be set to only store a data fragment if the memory address of the data fragment is within a range of memory addresses. FIG. 5 depicts one example of the present invention that uses memory addresses.

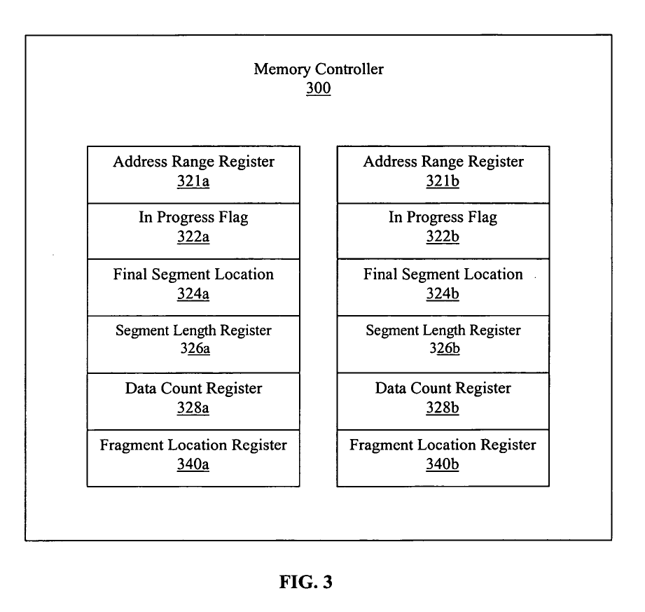

FIG. 3 is a schematic block diagram of one embodiment of a memory controller 300 corresponding to the memory controller 220 of FIG. 2. The depicted memory controller 300 is capable of tracking two (2) data segments within the data segment memory 230 as the memory controller 300 includes two address range registers 321a, 321b, two ‘in progress’ flags 322a, 322b, count registers 328a, 328b, and two fragment location registers 340a, 340b. The components of the memory controller 220 operate to aggregate data segments within the segment memory 230 two final segment locations 324a, 324b, two segment length registers 326a, 326b, two data

In certain embodiments, each data fragment received by the data transceiver 200 includes a memory location or address. In such embodiments, the memory controller 300 may include an address range register 321 that defines a range of memory addresses. In such embodiments, if a memory address of a received data fragment is within the range of addresses defined by the address range register 321, the memory controller 300 may store the received data fragment within the segment memory 230. The range of addresses defined by each address range register 321 may vary.

The ‘in progress’ flag 322 indicates whether the corresponding data count register 328 is tracking a data segment within the data segment memory 230. The final segment location 224 includes the location or address where the data segment will be ultimately located.

The segment length register 326 indicates the value the data count register 328 must reach before forwarding the entire data segment. In certain embodiments, the value of the segment length register 326 may be a value corresponding to the range of memory addresses defined by the address range register 321. The value in each segment length register 326 may be different. The data count register 328 indicates the current size of the data segment stored within the segment memory 330. The fragment location register indicates the appropriate location within the segment for the next data fragment.

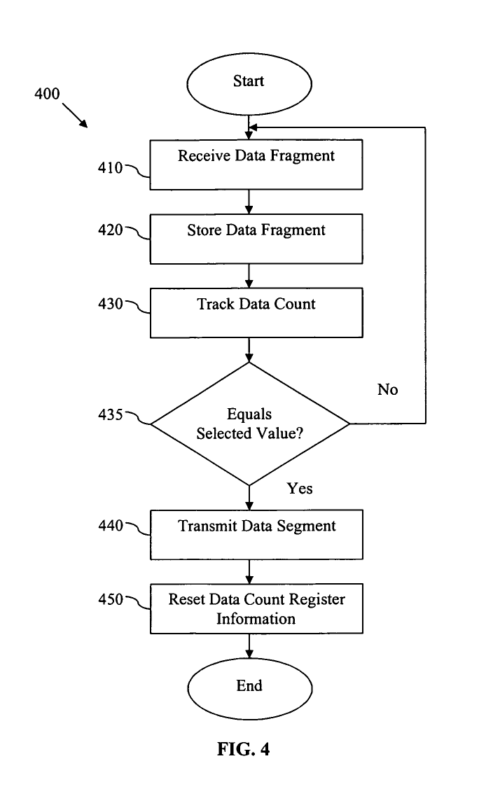

FIG. 4 is a schematic flow diagram of data transmission method 400. The depicted method 400 includes receiving 410 at least one data fragment corresponding to a data segment, storing 420 the at least one data fragment within a data segment memory, tracking 430 an accumulated data count for the data segment, testing 435 whether the data count attains a selected value, transmitting 440 the data segment if the accumulated data count attains a selected value, and resetting 450 the accumulated data count in response to transmitting the data segment. The operations of the method 400 reduce data transmission overhead by collecting multiple data fragments and transmitting a single data segment.

Receiving 410 at least one data fragment corresponding to a data segment may include a fragment receiving module 210 receiving a data fragment from a data fragment source 110. Storing 420 the at least one data fragment within a data segment memory may include a memory controller 220 storing the at least one data fragment in a segment memory 230. Tracking 430 an accumulated data count for the data segment may include updating data in a data count register 328a, 328b of a memory controller 300. Tracking 430 may also include updating data in the memory controller 300 to reflect the data segment in the segment memory 230. A more detailed example is given in the description of the embodiment of FIG. 5.

Testing 435 whether the data count attains a selected value may include testing whether the value in the data count register 328 is equal to the segment length register 326. In such embodiments, if the data count register 328 is equal to the segment length register 326, the data segment is transmitted 440. If the data count register 328 is not equal to the segment length register 326, the data segment remains in the segment memory 230 and the memory controller 300 receives 410 an additional data fragment. In certain embodiments, the data segment is transmitted 440 if the data count register 328 is equal to or greater than the segment length register 326.

Transmitting 440 the data segment may include transmitting the data segment within the segment memory 230 according to the final location segment location 324 within in the memory controller 300. Resetting 450 the accumulated data count register may include resetting the values in the data count register 328 to reflect the absence of a data segment in the segment memory 230. More particularly, resetting 450 the accumulated data count register may include resetting or adjusting the ‘in progress’ flag 322, the final segment location 324, the data count register 328, and the fragment location register 340.

FIGS. 5a-5i are schematic block diagrams of a memory controller 500a and a corresponding segment memory 510a. Viewed sequentially, FIGS. 5a-5h illustrate the reception and storage of data fragments, the tracking and transmission of a data segment, and the resetting of the memory controller 500a. The depicted memory controller 500a and segment memory 510a include an example of the present invention using memory addresses. The depicted memory controller 500a includes an address range register 520a, an ‘in progress’ flag 530a, a final segment address 540a, a segment length register 550a, a data count register 560a, and a fragment address register 570a. It should be noted that in embodiments wherein a memory controller 500a tracks multiple data segments within the segment memory 510a, the registers and values depicted in the memory controller 500a could be duplicated for each data segment.

Referring to FIG. 5a, the memory controller 500a receives a data fragment 510a. Because there is no data segment stored in the segment memory 510a, the ‘in progress’ flag 530a, the final segment address 540a, the data count register 560a, and the fragment address register 570a are all set to zero (0). The segment length register 560a is set to 400h because 400h has been selected as the anticipated segment transmission size. Because the incoming data fragment 510a includes an address (ffff0000) outside the values within the address range register 520a (abcdxxxx), the memory controller 400b does not store the data fragment 510a in the segment memory 510b. Accordingly, the data fragment 510a is forwarded by a transmission module 240 according to the data fragment address (ffff0000 ).

Referring to FIG. 5c, the memory controller 500c receives a data fragment 512c. Because the address of the incoming data fragment 512c (abcde000) falls within the values of the address range register 520c, the data fragment 512c is stored within the segment memory 510d. As a data fragment 512c is now stored in the segment memory 510d, the memory controller 500d is updated.

Accordingly, the ‘in progress’ flag 530d is changed to one (1) to indicate the data segment 518d in the segment memory 510d, the final segment address 540d is set to the address of the data fragment 512c, the data count register 560d is now set to 100h to reflect the current size of the data segment 518d, and the fragment address register is set to 100h to indicate the cut-off point of the current data segment 518d and the appropriate positioning of the next data fragment within the segment memory 510d. The data segment 518d is positioned approximately seven eighths (⅞) down the length of the data segment memory 510d to represent the appropriate size of the data segment memory 510d according to the data volume required by the number of variables in the ranger register 520d (abcdxxxx).

Referring to FIG. 5e, the memory controller 500e receives a second data fragment 514e. Because the address of the incoming data fragment 514e (abcde100) falls within the address values of the address range register 520e, the data fragment 514e is also stored within the segment memory 510f. Consequently, the data count register 560f changes from 100h to 300h, to reflect the current size of the data segment 518f. The fragment address register 560f is set to 300h to indicate the cut-off point of the current segment 518f and the correct placement of the next data fragment. The ‘in progress’ flag 530f does not change as there is still a segment 518f within the segment memory 510f and the final segment address 57f has not changes as the proper segment destination has likewise not changed.

Referring to FIG. 5g, the memory controller 500g receives a third data fragment 516g. As the address of the incoming data fragment 516g (abcde300) falls within the address values of the address range register 520g, the data fragment 516g is stored within the segment memory 510h. As the data fragment 516g is now stored in the segment memory 510h, the memory controller 400h is updated. The data count register 560g is now set to 400h to reflect the current size of the data segment 518g and the fragment address register 570g is set to 400h to indicate the cut-off point of the current data segment 518g. The ‘in progress’ flag does not change as there is still a segment 518g within the segment memory 510f and the final segment address 540g has not changes as the ultimate segment destination has likewise not changed.

Because the value in the data count register 560h equals the value in the segment length register 550h, the data segment 518h is forwarded according to the final segment address 540h. Referring to FIG. 4i, once the data segment is forwarded, the values within the memory controller 500i are reset. More specifically, the ‘in progress’ flag 530i, the final segment address 540i, the data count register 560i, and the fragment address register 540i are all reset to zero (0) because there is no data segment in the segment memory 510i.

FIG. 6a-6c are data tracking diagrams in accordance with the present invention. Viewed sequentially, FIGS. 6a-6c represent reception, storage, and transmission of data fragments and data segments. Referring to FIG. 6a, the depicted table represents a table of received fragments. Each fragment includes an address, a fragment length, and data. As the fragments are received they are stored in a segment memory according to the segment to which each fragment correspond.

Referring to FIG. 6b, the depicted table represents a segment memory 510. Each segment within the segment memory 510 includes an address desired length, current length, and data. As depicted, the segment memory 610 stores multiple data segments according to address (i.e. address 1000, 1010, and 2000). Once the current length of the data segment is equal to the desired length, the data segment is ready for transmission. For example, referring to the segment with the address 1000, the current length of segment is equal to the desired length of the segment. Accordingly, the segment with the address 100 is ready for transmitted as depicted in FIG. 6c.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for reducing data transmission overhead, the apparatus comprising:
a fragment receiving module configured to receive at least one data fragment corresponding to a data segment;
a memory controller configured to store the at least one data fragment within a data segment memory, the memory controller comprising a data count register configured to track an accumulated data count for the data segment; and
a data transmission module configured to forward the data segment if the accumulated data count attains a selected value.

2. The apparatus of claim 1, wherein the memory controller is further configured to reset the data count register if the data segment is forwarded from the data segment memory.

3. The apparatus of claim 1, wherein the memory controller comprises multiple data count registers each configured to track a data count for a data segment and the segment memory is configured to store multiple data segments simultaneously.

4. The apparatus of claim 1, wherein the memory controller is further configured to order the at least one data fragment within the segment memory according to a selected order.

5. The apparatus of claim 1, wherein the data transmission module is further configured to forward any data fragments in response to an error.

6. The apparatus of claim 1, wherein the data transmission module is further configured to forward any data fragments within the data segment memory according to a selected interval of time.

7. The apparatus of claim 1, wherein each of the at least one data fragment includes a memory address.

8. A computer readable medium comprising a computer code configured to carry out a method for reducing data transmission overhead, the method comprising:
receiving at least one data fragment corresponding to a data segment;
storing the at least one data fragment in a data segment memory;
tracking an accumulated data count for the data segment; and
forwarding the data segment if the accumulated data count attains a selected value.

9. The computer readable medium of claim 8, wherein the method further comprises resending the accumulated data count in response to forwarding the data segment.

10. The computer readable medium of claim 8, wherein the method further comprises tracking a data count for multiple data segments, wherein the segment memory is configured to store multiple data segments simultaneously.

11. The computer readable medium of claim 8, wherein storing the at least one data fragment within a data segment memory comprises ordering the at least one data fragment according to a selected order.

12. The computer readable medium of claim 8, wherein the method further comprises forwarding the at least one data fragment in response to an error.

13. The computer readable medium of claim 8, wherein the method further comprises forwarding the data segment according to a selected interval of time.

14. The computer readable medium of claim 8, wherein a data fragment of the at least one data fragment comprises a memory address.

15. A system for reducing data transmission overhead, the system comprising:
a data fragment source configured to communicate at least one data fragment corresponding to a data segment;
a data transceiver configured to receive at least one data fragment corresponding to a data segment; the data transceiver further configured to store the at least one data fragment; the data transceiver further configured to track an accumulated data count for the at least one data segment; the data transceiver further configured to forward the data segment if the accumulated data count attains a selected value; and
a data segment receiver configured to receive the data segment.

16. The system of claim 15, wherein the data transceiver is further configured to store multiple data segments simultaneously.

17. The system of claim 15, wherein the data transceiver is configured to order data fragments according to a selected order.

18. The system of claim 15, wherein the data fragment source comprises an integrated circuit.

19. The system of claim 15, wherein the data fragment source comprises a PCI interface.

20. The system of claim 15, wherein a data segment receiver comprises a data bearing medium.
